(19) United States
(12) Patent Application Publication
(10) Pub. No.: US 2017/0247038 A1
(43) Pub. Date: Aug. 31, 2017

(54) Method For Estimating A Vehicle Side Slip Angle, Computer Program Implementing Said Method, Control Unit Having Said Computer Program Loaded, And Vehicle Comprising Said Control Unit

(71) Applicants: Politecnico Di Milano, Milan (IT); Maserati S.p.A., Modena (IT)

(72) Inventors: Sergio Matteo SAVARESI, Cremona (IT); Matteo CORNO, Milan (IT); Donald SELMANAJ, Milan (IT); Giulio PANZANI, Monza (IT); Christian GIRARDIN, Candelo (IT); Giovanni BUSSALAI, Torino (IT)

(21) Appl. No.: 15/518,495

(22) PCT Filed: Oct. 20, 2014
(86) PCT No.: PCT/EP2014/072439

§ 371 Date: Apr. 12, 2017

(51) Int. Cl. B60W 40/103; B60W 40/112; B60W 40/105; B60W 40/114; B60W 40/107; B60W 40/109

(52) U.S. Cl. CPC B60W 40/103; B60W 40/107; B60W 40/109; B60W 40/105; B60W 40/114; B60W 40/112; B60W 2520/125; B60W 2520/14; B60W 2520/105; B60W 2520/20; B60W 2520/28; B60W 2520/26; B60W 2720/106; B60W 2720/125; B60W 2720/14; B60W 2720/20; B60W 2720/26; B60W 2720/28; B60W 2520/18; B60W 2720/18

(57) ABSTRACT

The present invention relates to a method for estimating the side slip angle (β^{stim}) of a four-wheeled vehicle, comprising: —detecting signals representing the vehicle longitudinal acceleration (Ax), lateral acceleration (Ay), vertical acceleration (Az), yaw rate (formula I), roll rate (formula II), wheels speeds (V_{FL}, V_{FR}, V_{RL}, V_{RR}); —pre-treating (1) said signals in order to correct measurement errors and/or noises, so to obtain corrected measurements of at least the longitudinal acceleration (aₓ), the lateral acceleration (a_{y}), the yaw rate (formula I) and the wheels speeds (ν_{FL}, ν_{FR}, ν_{RL}, ν_{RR}), —determining (2) an estimated vehicle longitudinal speed (Vₓ^{stim}) on the basis of at least one of the corrected measurements of the wheel speeds (ν_{FL}, ν_{FR}, ν_{RL}, ν_{RR}); —determining a yaw acceleration (formula III) from the signal representing the yaw rate (formula I); —solving (25) a time-depending parametrical non-linear filter, such as a Kalman filter or a Luenberger filter, describing the vehicle longitudinal and lateral speeds (formula IV) and longitudinal and lateral accelerations (formula V) as a function of the corrected measurements of the longitudinal acceleration (aₓ), of the lateral acceleration (a_{y}), of the yaw rate (formula I) and the estimated vehicle longitudinal speed (Vₓ^{stim}) and of a filter parameter (F) depending from depending from at least one of the vehicle yaw acceleration (formula III), yaw rate (formula I) and lateral acceleration (ay) which adds a negative component to the lateral acceleration (formula VI) determined by the filter itself, said filter parameter (F) being selected such that said negative component reaches a maximum value when it is determined that the vehicle is moving straight on the basis of said at least one of the vehicle yaw acceleration (formula III), yaw rate (formula I) and lateral acceleration (ay); —determining the vehicle estimated side slip angle (β^{stim}) from said longitudinal and lateral vehicle speeds (formula IV) determined by solving the non-linear filter. The present invention further relates to a computer program implementing said method, a control unit having said computer program loaded, and a vehicle comprising said control unit.

### BACKGROUND

Technical Field

The present invention relates to a method for estimating side slip angle of a vehicle, particularly of a four-wheeled vehicle. Knowing the side slip angle can be of use for example in the stability control of the vehicle itself.

The vehicle side slip angle (also known as the body vehicle side slip angle) is the angle between the velocity vector measured at the centre of gravity and the longitudinal axis of the vehicle.

Description of the Related Art

The need of estimating the side slip angle of a vehicle is increasingly felt, particularly for safety reasons and for the vehicle stability control.

Since measurement of the side slip angle is difficult, several methods for estimating the same have been proposed.

In order to estimate the side slip angle two different approaches are currently known. In a first approach (dynamic approach) dynamic quantities of the vehicle are used, whilst in a second approach (cinematic approach) only cinematic quantities are used.

### BRIEF SUMMARY OF THE INVENTION

It has been observed that known approaches for estimating the side slip angle are unsatisfactory because of the poor resulting estimation and for the algorithm computation complexity.

Hence, it has been found convenient a cinematic approach in which a side slip angle estimation is performed by making use of a non-linear filter incorporating a vehicle cinematic model, such as a Kalman or a Luenberger filter, in which the non-linear filter contains a parameter which is continuously updated during motion of the vehicle as a function of the vehicle yaw rate and/or the yaw acceleration and/or the lateral acceleration.

Therefore, the present invention relates to a method for determining the side slip angle of a vehicle according to the appended claim 1.

Dependent claims 2-16 relate to particular advantageous embodiments of the method of claim 1.

The present invention further relates to a computer program loadable in a control unit of a vehicle according to claim 17.

The present invention further relates to a control unit of a vehicle according to claim 18.

The present invention further relates to a vehicle according to claim 19.

### BRIEF DESCRIPTION OF THE DRAWINGS

Further characteristics and advantages will be more apparent from the following description of a preferred embodiment and of its alternatives given as a way of an example with reference to the enclosed drawings in which:

FIG. 1a shows a reference system associated to a vehicle for which the side slip angle is to be calculated;

FIG. 1b shows schematically a situation of sensors not aligned with the vehicle axes X, Y, Z;

FIG. 1c shows schematically the compensation of the effect of gravity on the lateral acceleration Ay due to the vehicle roll;

FIG. 2 is a block diagram illustrating a method for estimating the side slip angle of a vehicle according to a possible embodiment of the invention;

FIG. 3 is a detailed block diagram of module 7 in FIG. 2 according to a possible embodiment;

FIG. 4 is a detailed block diagram of a part of module 13 in FIG. 2 according to a possible embodiment;

FIG. 5 is a detailed block diagram of a further part of module 13 in FIG. 2 according to a possible embodiment;

FIG. 6 is a detailed block diagram of a further part of module 13 in FIG. 2 according to a possible embodiment;

FIG. 7 is a detailed block diagram of module 15in FIG. 2 according to a possible embodiment;

FIG. 8 shows a possible curve describing a parameter F of a non-linear filter used for determining the estimated side slip angle in the method according to the invention.

### DETAILED DESCRIPTION

In the following description, same alphanumeric references are used for analogous exemplary elements when they are depicted in different drawings.

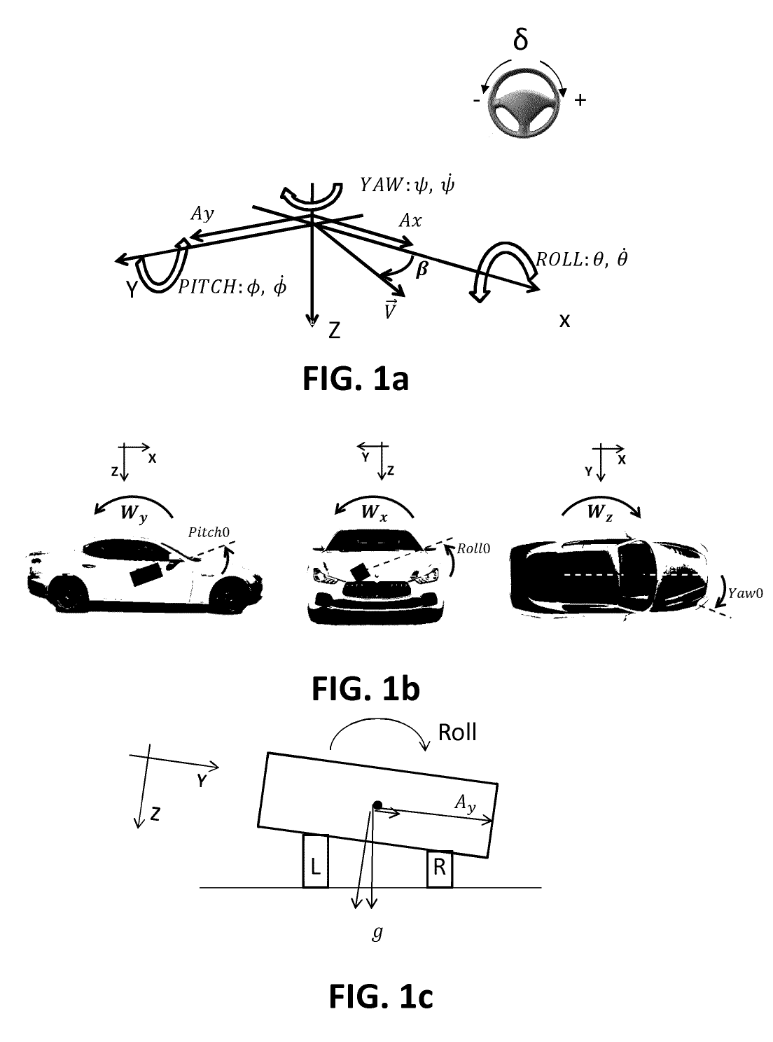

FIG. 1a schematically shows a reference system for a vehicle. Axes X, Y, Z respectively are the longitudinal, transversal and vertical axes of the vehicle. As it is known to the skilled person, roll, yaw and pitch indicate the rotation of the vehicle about respectively axis X, axis, Y, and axis Z. As it is shown in FIG. 1a:
roll and roll rate are respectively indicated as θ, \dot{θ};
yaw and yaw rate are respectively indicated as ψ, \dot{ψ},
pitch and pitch rate are respectively indicated as φ, \dot{φ}.

Moreover, Ax and Ay respectively indicate the vehicle acceleration along axis X and Axis Y, i.e. the longitudinal acceleration and the lateral acceleration.

Vector \vec{V} indicates the actual vehicle velocity, and β indicates the vehicle side slip angle, i.e. the angle between vector \vec{V} and axis X;

δ represents the steering angle.

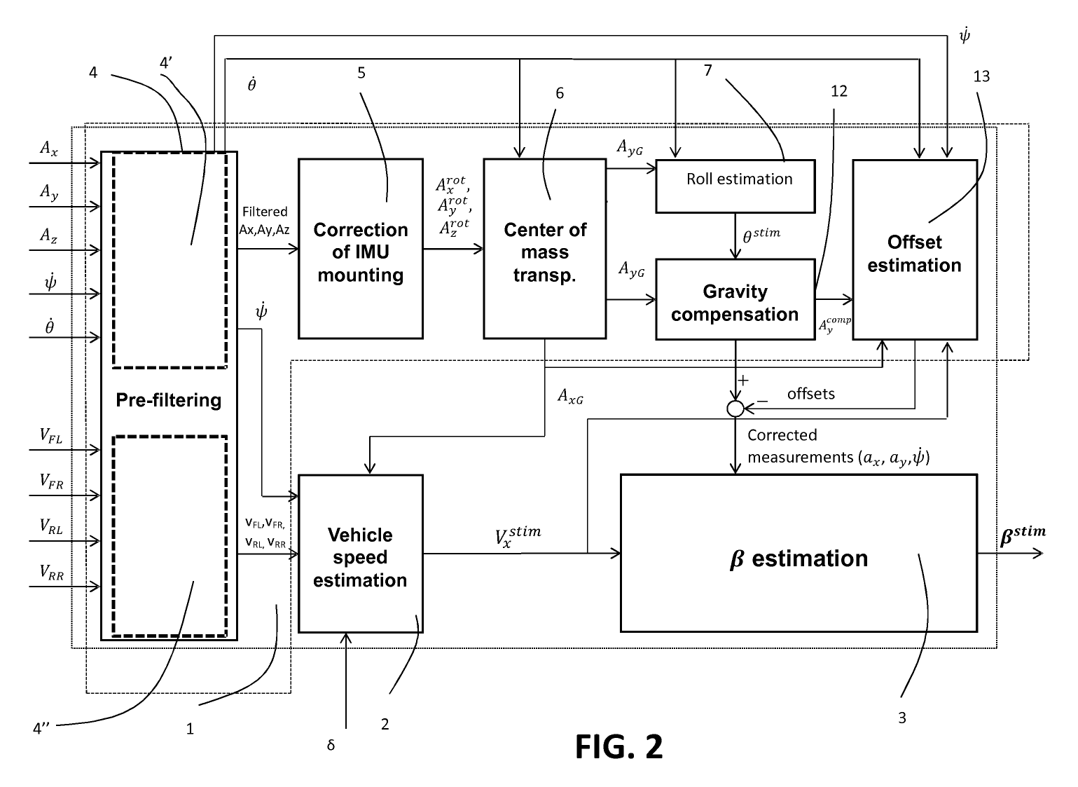

FIG. 2 shows a block diagram schematically depicting a method for estimating the side slip angle of a vehicle according to a possible embodiment of the invention. The method determines an estimated vehicle side slip angle β^{stim} on the basis of several inputs which are measures of cinematic quantities detected for example by corresponding sensors provided on the vehicle, each sensor being suitable to generate a signal representing the measured cinematic quantity. Hence, the method according to the invention comprises detecting signals representing at least the following cinematic quantities:
vehicle longitudinal Ax, lateral Ay and vertical Az accelerations, which can be detected for example by a suitable Inertial Measurement Unit (“IMU”) mounted on the vehicle;
vehicle yaw rate \dot{ψ} and roll rate \dot{θ}, which can be detected for example by respective gyros mounted on the vehicle;
linear speeds of the vehicle wheels, particularly of the left front wheel V_{FL}, of the right front wheel V_{FR}, of the left rear wheel V_{RL} and of the right rear wheel V_{RR}. In general, sensors associated to the wheels actually detects their angular speeds and then the linear speed can be determined on the basis of the angular speed detected and the wheel radius. For example, encoders, or resolvers or the like can be used for determining angular speeds.

Ingoing signals are pre-treated in a corresponding pre-treating step, indicated schematically as a module 1 in dotted line in FIG. 2. Module 1 in turn can comprise several modules corresponding to method steps whose details will described below. The pre-treating steps corresponding to module 1 result in the determination of corrected measurements of longitudinal acceleration aₓ, lateral acceleration a_{y}, and yaw rate \dot{ψ}, and corrected measurements of the left front wheel ν_{FL}, of the right front wheel ν_{FR}, of the left rear wheel ν_{RL} and of the right rear wheel ν_{RR}.

Corrected measurements of the wheels speeds and preferably also steering angle δ are inputs for a module 2 (“Vehicle speed estimation”) which can realize a method step of determining an estimated vehicle longitudinal vehicle speed Vₓ^{stim}. Further details of module 2 will be given below.

Corrected measurements of longitudinal acceleration aₓ, lateral acceleration a_{y}, and yaw rate \dot{ψ} and estimated vehicle longitudinal vehicle speed Vₓ^{stim} are inputs into a module 3 (“β estimation”), which actually determines an estimated side slip angle β^{stim} on the basis of these inputs. The method steps underlying module 3 will be also described in great detail below.

A detailed description of each module shown in FIG. 2 will be hereinafter given.

In accordance with an embodiment, module 1 comprises a module 4 (“Pre-filtering”) which realizes a method step of filtering the signals representing the cinematic quantities detected by the sensors installed on the vehicle. Particularly module 4 comprises a first filtering module 4′ for filtering the signals representing the vehicle cinematic quantities (i.e. vehicle longitudinal acceleration Ax, lateral acceleration Ay and vertical acceleration Az, vehicle yaw rate \dot{ψ} and vehicle roll rate \dot{θ}) and a second filtering module 4″ for filtering the signals representing the wheels cinematic quantities (i.e. front left wheel speed V_{FL}, front right wheel speed V_{FR}, rear left wheel speed V_{RL}, rear right wheel speed V_{RR}). Filtering is mainly performed in order to remove noise in the signals. Particularly, some measurements can be influenced by the vehicle vertical dynamics. Signals are advantageously filtered by a low-pass filter. The choice of the cutoff frequency depends on the vehicle considered.

In accordance with an embodiment, module 1 comprises a module 5 (“Correction of IMU mounting”) which realizes a method step of correcting the signals (preferably the signals filtered in module 4′) representing the vehicle accelerations, i.e. the vehicle longitudinal acceleration Ax, lateral acceleration Ay and vertical acceleration Az. Module 5 and the corresponding method step can be necessary in the case the sensors for detecting the vehicle accelerations, for example the IMU, are not aligned with the vehicle axis, i.e. forming angles roll₀ (static roll), pitch₀ (pitch mounting) and yaw₀ (static yaw) with the vehicle axes X, Y, Z. The situations is illustrated in FIG. 1B.

Static roll, pitch mounting and static yaw, if not already known, can be determined for example as follows.

Measurements of vehicle longitudinal acceleration Ax, lateral acceleration Ay and vertical acceleration Az with vehicle in stopped conditions are performed. Then, for each component of the acceleration, a mean value of the detected samples is calculated. Mean values of longitudinal acceleration, lateral acceleration and vertical acceleration are indicated as Axₘₑₐₙ,Ayₘₑₐₙ,Azₘₑₐₙ.

Then, static roll roll₀ and pitch mounting pitch₀ can be calculated with the following formulae:

$${PITCH}_{0} = a tan ( - \frac{{Ax}_{mean}}{{Az}_{mean}} )$$

$${ROLL}_{0} = a tan ( \frac{{Ay}_{mean}}{cos ( PITCH ) {Az}_{mean} - sin ( {PITCH}_{0} ) {Ax}_{mean}} )$$

The static yaw yaw₀ can be evaluated as the yaw such that the error between the accelerations measured (longitudinal Ax and/or lateral Ay) and the actual accelerations (for example measured with an already tuned sensor) is minimized. For the error minimization, the root mean square of the error can be calculated.

Once static roll, pitch mounting and static yaw are identified, the values of longitudinal acceleration Ax, lateral acceleration Ay and vertical acceleration Az as entered into module 5 can be corrected by means of a rotation matrix, thereby obtaining corrected values Aₓ^{rot}, A_{y}^{rot}, A_{z}^{rot}. For example the acceleration corrected values Aₓ^{rot}, A_{y}^{rot}, A_{z}^{rot} can be calculated with the following formula:

$$\begin{matrix}[ \begin{matrix}{A}_{x}^{rot} \\ {A}_{y}^{rot} \\ {A}_{z}^{rot}\end{matrix} ] = {R}_{zyx}^{T} [ \begin{matrix}{A}_{x} \\ {A}_{y} \\ {A}_{z}\end{matrix} ] & \\ wherein \text{:} & \\ {R}_{zyx} = {R}_{z} {R}_{y} {R}_{x} & \\ and \text{:} & \\ {R}_{x} = [ \begin{matrix}1 & 0 & 0 \\ 0 & cos ( {roll}_{0} ) & s in ( {roll}_{0} ) \\ 0 & - sin ( {roll}_{0} ) & cos ( {roll}_{0} )\end{matrix} ] \\ {R}_{y} = [ \begin{matrix}cos ( {pitch}_{0} ) & 0 & - sin ( {pitch}_{0} ) \\ 0 & 1 & 0 \\ s in ( {pitch}_{0} ) & 0 & cos ( {pitch}_{0} )\end{matrix} ] \\ {R}_{z} = [ \begin{matrix}cos ( {yaw}_{0} ) & sin ( {yaw}_{0} ) & 0 \\ - sin ( {yaw}_{0} ) & cos ( {yaw}_{0} ) & 0 \\ 0 & 0 & 1\end{matrix} ] & \end{matrix}$$

In accordance with an embodiment, module 1 comprises a module 6 (“Center of mass meas.”) which realizes a method step of correcting the signals representing the longitudinal acceleration Ax, the lateral acceleration Ay and the vertical acceleration Az (preferably previously corrected in module 4′ and/or in module 5) in case the sensors for detecting the vehicle accelerations, for example the IMU, are not positioned exactly in the vehicle centre of gravity.

In principle, the correction of longitudinal acceleration Ax, lateral acceleration Ay and vertical acceleration Az into corresponding values Ax_{G}, Ay_{G}, Az_{G} in which the sensor position relative to the center of gravity is taken into consideration can be calculated with the following formulae:

A_{xG}=Aₓₚ−(zₚ\ddot{φ}−yₚ<\ddot{ψ})+xₚ\dot{ψ}²−zₚ\dot{ψ}\dot{θ}+xₚ\dot{φ}²−yₚ\dot{φ}\dot{θ}

A_{yG}=A_{yp}+(zₚ\ddot{θ}−xₚ<\ddot{ψ})+yₚ\dot{ψ}²−zₚ\dot{ψ}\dot{φ}+yₚ\dot{φ}²−xₚ\dot{φ}\dot{θ}

A_{zG}=A_{zp}−(yₚ\ddot{θ}−xₚ<\ddot{φ})+zₚ\dot{φ}²−yₚ\dot{ψ}\dot{φ}+zₚ\dot{θ}²+xₚ\dot{ψ}\dot{θ}

wherein xₚ, yₚ and zₚ indicate the sensor position in the previously described reference system X, Y, Z relative to the center of gravity, which can be conventionally considered the origin of the axes.

It has however verified that the pitch influence, which is not an input of the system, is negligible. Hence, the corrected values of the longitudinal acceleration Ax_{G}, lateral acceleration Aye and vertical acceleration Az_{G} can be calculated with the following simplified formulae:

$$\{ \begin{matrix}{A}_{xG} = {A}_{xp} + {x}_{p} {\dot{ψ}}^{2} - {z}_{p} \dot{ψ} \dot{θ} \\ {A}_{yG} = {A}_{yp} + {y}_{p} {\dot{ψ}}^{2} + {y}_{p} {\dot{θ}}^{2} \\ {A}_{zG} = {A}_{zp} + {z}_{p} {\dot{θ}}^{2} + {x}_{p} \dot{ψ} \dot{θ}\end{matrix}$$

The yaw rate \dot{ψ} and the roll rate \dot{θ} in the above formula are preferably pre-filtered in the modules 4′ and 4″.

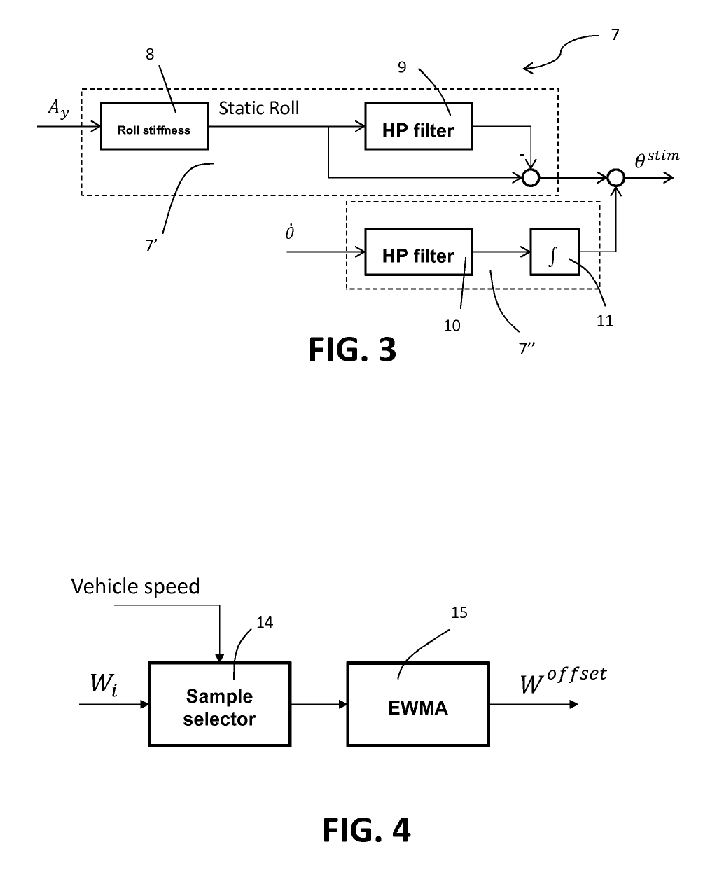

In accordance with an embodiment, module 1 comprises a module 7 (“Roll estimation”) which realizes a method step of determining an estimated vehicle roll θ^{stim} on the basis of the lateral acceleration Ay and of the roll rate \dot{θ}, preferably previously corrected as described above in modules 4′, 5, 6. A possible detailed block representation of module 7 is shown in FIG. 3.

A simple integration of the detected roll rate \dot{θ} is not sufficient for obtaining a reliable estimation of the vehicle roll since errors would tend to accumulate with the integrations. In order to overcome such a problem, a separation of dynamic roll and static roll may be realized.

As shown in FIG. 3, module 7 advantageously comprises a first module 7′ which realizes a method step of estimating an estimated static roll, and a second module 7″ which realizes a method step of estimating an estimated dynamic roll. The estimated vehicle roll θ^{stim} is finally determined as the sum of the estimated static roll and of the estimated dynamic roll.

With reference to FIG. 3, in the first module 7′ a static roll is determined starting from the lateral acceleration Ay (possibly previously pre-treated in modules 4′, 5, 6). In static conditions (i.e. when Ay is constant), there is a bi-univocal relationship between the lateral accelerations Ay and the vehicle roll, which is mainly due to suspensions configuration and stiffness which can be experimentally determined. On the basis of such relationship, in a module 8 (“Roll stiffness”) a static roll is determined. Then, a frequency separation of the so determined static roll is performed by subtracting from the static roll the same static roll filtered in a high-pass filter 9 (“HP filter”).

In module 7″ the roll rate \dot{θ} (preferably previously pre-treated in module 4′) is filtered in a second high-pass filter 10 and then integrated in an integrator module 11 (“∫”), thereby obtaining a dynamic roll.

The result in the elaboration of the static roll in module 7′ is then summed to the dynamic roll determined in module 7″, thereby obtaining the estimated vehicle roll θ^{stim}.

In accordance with an embodiment, module 1 comprises a module 12 (“Gravity compensation”) which realizes a method step of compensating the effect of gravity on the lateral acceleration Ay due to the vehicle roll θ. The compensation is realized on the basis of the estimated vehicle roll θ^{stim} determined in module 7. In fact, when a roll is present, a component of the gravity acceleration is present along the Y axis, which is to be excluded and subtracted from the signal representing the lateral acceleration. The situation is illustrated in FIG. 1c. For example, the compensated lateral acceleration A_{y}^{comp} can be calculated with the following formula:

A_{y}^{comp}=A_{y}−g·cos(θ^{stim})

Preferably the incoming acceleration Ay is previously pre-treated in modules 4′, 5, and 6.

In accordance with an embodiment, module 1 comprises a module 13 (“Offset estimation”) which realizes a method step of compensating other offsets present in the signals representing the longitudinal acceleration Ax, the lateral acceleration Ay, the yaw rate \dot{ψ} and the roll rate \dot{θ}.

With reference to the gyro offset, i.e. the offsets in the yaw rate \dot{ψ} and in the roll rate \dot{θ}, they are mainly electrical offsets. Hence, due to the electric offsets, even when vehicle is stopped the signals representing yaw rate \dot{ψ} and the roll rate \dot{θ} are different from zero.

In order to determine the gyro offset, several samples of the signal representing the quantity of interest (yaw rate \dot{ψ} or the roll rate \dot{θ}, preferably previously pre-treated in module 4′) can be collected for a preselected time while maintaining the vehicle stopped. Then a mean value of the samples can be calculated. Preferably, the mean value is calculated as an exponentially weighted moving average.

The above steps are schematically represented in the block diagram in FIG. 4. The angular speed of interest Wi (which can be either the yaw rate \dot{ψ} or the roll rate \dot{θ}) enters in a module 14 (“Sample selector”) which collects the samples only when the vehicle is stopped. For this reason the vehicle speed is also indicated as an input of the module 14. The samples exponentially weighted moving average is calculated in a module 15 (“EWMA”) which determines the offset of the angular speed of interest W^{offset}.

With reference to the longitudinal and lateral accelerations, again, electrical offsets are present in the signals which may result in measurements different from zero even in the case there are no actual accelerations.

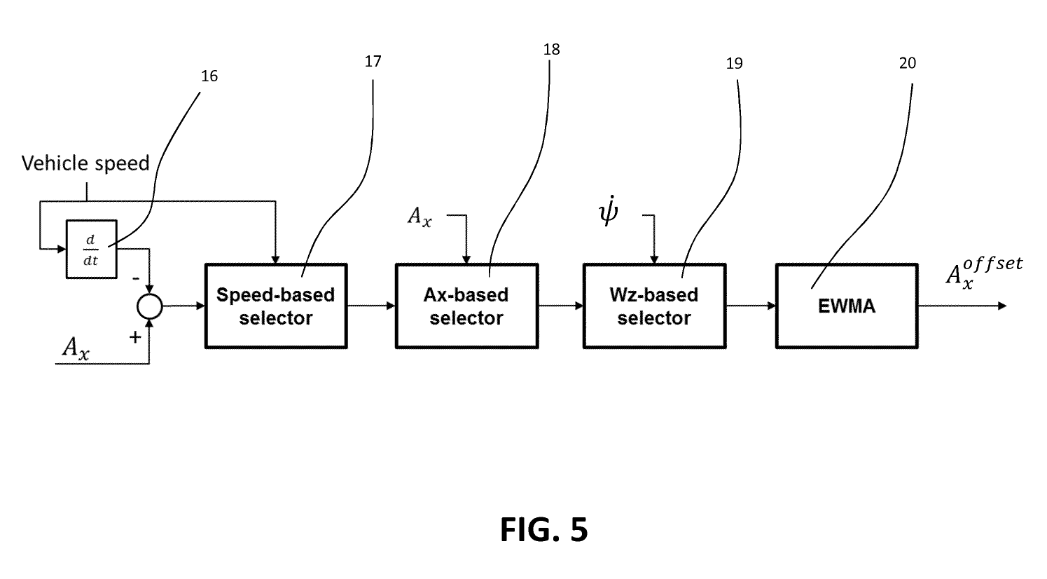

Referring to the longitudinal acceleration Ax, offsets can be determined in a similar manner as discussed for the gyro offsets. However, the samples are to be collected while the vehicle is in motion. Moreover, it is to be considered that, since vehicle pitch and lateral dynamics affect the longitudinal acceleration Ax measures, high longitudinal acceleration and high yaw rate conditions are preferably to be excluded. A block diagram representing possible steps for determining the longitudinal acceleration offset is shown in FIG. 5. The longitudinal acceleration Ax is preferably previously pre-treated in modules 4′,5, 6.

Hence, with reference to a possible embodiment shown in FIG. 5, several samples of the signal representing the longitudinal accelerations Ax are collected for a preselected time while the vehicle is moving. At the same time, the vehicle speed is considered (For example, the estimated longitudinal vehicle speed Vₓ^{stim} calculated in module 2 can be used as an input) and the derivative thereof is calculated in a module 16 so to obtain an acceleration. The difference between the longitudinal acceleration Ax sample and the vehicle speed derivative represents an acceleration offset.

The so determined offset samples are preferably excluded when:
the vehicle speed exceeds a predetermined vehicle speed value. This step corresponds to a module 17 (“Speed-based selector”); and/or
the longitudinal acceleration Ax exceeds a predetermined vehicle longitudinal acceleration value. This step corresponds to a module 18 (“Ax-based selector”); and/or
the yaw rate \dot{ψ} exceeds a predetermined vehicle yaw rate value. This step corresponds to a module 19 (“Wz-based selector”).

Finally, a mean value of the selected samples can be calculated, thereby obtaining the longitudinal acceleration offset Aₓ^{offset}. This step corresponds to a module 20 (“EWMA”) in FIG. 5. Preferably, the mean value is calculated as an exponentially weighted moving average, preferably tuned with the same parameter used for calculating the exponentially weighted moving average for the gyro offset (Module 15 in FIG. 4).

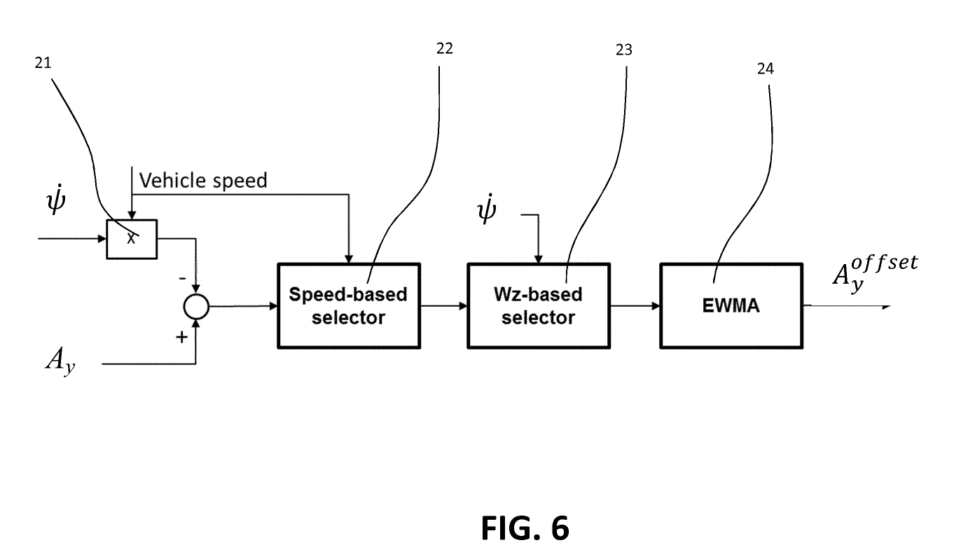

Referring now to the lateral acceleration Ay, the offsets can be determined in a similar manner as discussed for the longitudinal acceleration Ax. Again, the samples are to be collected while the vehicle is in motion. Moreover, high yaw rate conditions are preferably to be excluded. A block diagram representing possible steps for determining the lateral acceleration offset is shown in FIG. 6. The lateral acceleration Ay is preferably previously pre-treated in modules 4′,5, 6, 7, 12.

Hence, with reference to possible embodiment shown in FIG. 5, several samples of the signal representing the lateral accelerations Ay are collected for a preselected time while the vehicle is moving. At the same time, the yaw rate \dot{ψ}, preferably the real yaw rate (i.e. the detected yaw rate already corrected by subtracting the yaw rate offset, calculated for example as discussed above) is measured and multiplied by the vehicle speed Vx, (for example the estimated longitudinal vehicle speed Vₓ^{stim} calculated in module 2) in a module 21 (“x”) so to obtain an acceleration. The difference between the lateral acceleration Ay sample and the acceleration calculated as discussed in module 21 represents a lateral acceleration offset.

However, the so determined offset samples are preferably excluded when:
the vehicle speed exceeds a predetermined vehicle speed value. This step corresponds to module 22 (“Speed-based selector”); and/or
the yaw rate \dot{ψ} exceeds a predetermined vehicle yaw rate value. This step corresponds to module 23 (“Wz-based selector”).

Finally, a mean value of the selected samples can be calculated, thereby obtaining the lateral acceleration offset A_{y}^{offset}. This step corresponds to module 24 (“EWMA”) in FIG. 6. Preferably, the mean value is calculated as an exponentially weighted moving average, preferably tuned with the same parameters used for calculating the exponentially weighted moving average for the gyro offset (module 15 in FIG. 4) and the exponentially weighted moving average for the longitudinal acceleration Ax (Module 20 in FIG. 5).

Turning back to FIG. 1, a detailed description of module 2 according to a possible embodiment, for determining an estimated vehicle longitudinal speed Vₓ^{stim}, is now given.

Since a direct measurement of the vehicle longitudinal speed is not available, it can be calculated starting from the wheels speed and from the signals coming from the sensors associated therewith. Particularly, advantageously, a longitudinal speed is determined for each wheel and then the four wheels speeds are considered for determining the estimated vehicle longitudinal speed Vₓ^{stim}.

Considering the front wheels only, the estimated vehicle speed can be determined in first instance by considering the detected front left wheel speed V_{FL} and front right wheel speed V_{FR} (preferably previously pre-filtered in module 4″) and the steering angle δ, with the following formulae, representing the projections of the wheels speeds on the X axis:

V_{FL}^{st}=V_{FL}·cos(δ)

V_{FR}^{st}=V_{FR}·cos(δ)

wherein:
V_{FL}^{st} indicates the estimated vehicle speed starting from the detected front left wheel speed V_{FL};
V_{FR}^{st} indicates the estimated vehicle speed starting from the detected front right wheel speed V_{FR}.

However, this approach does not consider the yaw rate effect. Hence, the estimated vehicle speed V_{FR}^{st}, V_{FR}^{st} as calculated above can be further corrected by subtracting the speed components due to the yaw rate. For the rear wheels, which in general are not subject to a steering angle, the yaw rate effect can be subtracted by the wheel speeds V_{RL}, V_{RR} calculated from the angular speeds detected by the sensors associated therewith. For example, the corrected estimated speeds V_{FL}^{comp}, V_{FR}^{comp}, V_{RL}^{comp}, V_{RR}^{comp} can be determined with the following formulae:

$${V}_{FL}^{comp} = {V}_{FL}^{st} - \dot{ψ} \frac{{carr}_{F}}{2}$$

$${V}_{FR}^{comp} = {V}_{FR}^{st} + \dot{ψ} \frac{{carr}_{F}}{2}$$

$${V}_{RL}^{comp} = {V}_{RL} - \dot{ψ} \frac{{carr}_{R}}{2}$$

$${V}_{RR}^{comp} = {V}_{RR} + \dot{ψ} \frac{{carr}_{R}}{2}$$

wherein:
carr_{F} represents the front axle track;
carr_{R} represents the rear axle track.

The estimated vehicle speed Vₓ^{stim} can be calculated from the four estimated speeds V_{FL}^{comp}, V_{FR}^{comp}, V_{RL}^{comp}, V_{RR}^{comp} as:

the minimum speed if the vehicle is accelerating (i.e. if the vehicle has a positive longitudinal acceleration Ax, which can be obtained from the signal representing the longitudinal acceleration, possibly pre-filtered in modules 4′,5 and 6):

Vₓ^{stim}=min(V_{FL}^{comp},V_{FR}^{comp},V_{RL}^{comp},V_{RR}^{comp})

the maximum speed if the vehicle is decelerating (i.e. if the vehicle has a negative longitudinal acceleration Ax):

Vₓ^{stim}=max(V_{FL}^{comp},V_{FR}^{comp},V_{RL}^{comp},V_{RR}^{comp})

the four speeds mean value if the vehicle is moving at a constant speed or having a low acceleration/deceleration, i.e. a longitudinal acceleration Ax comprised between an upper and a lower acceleration thresholds:

Vₓ^{stim}=min(V_{FL}^{comp},V_{FR}^{comp},V_{RL}^{comp},V_{RR}^{comp})

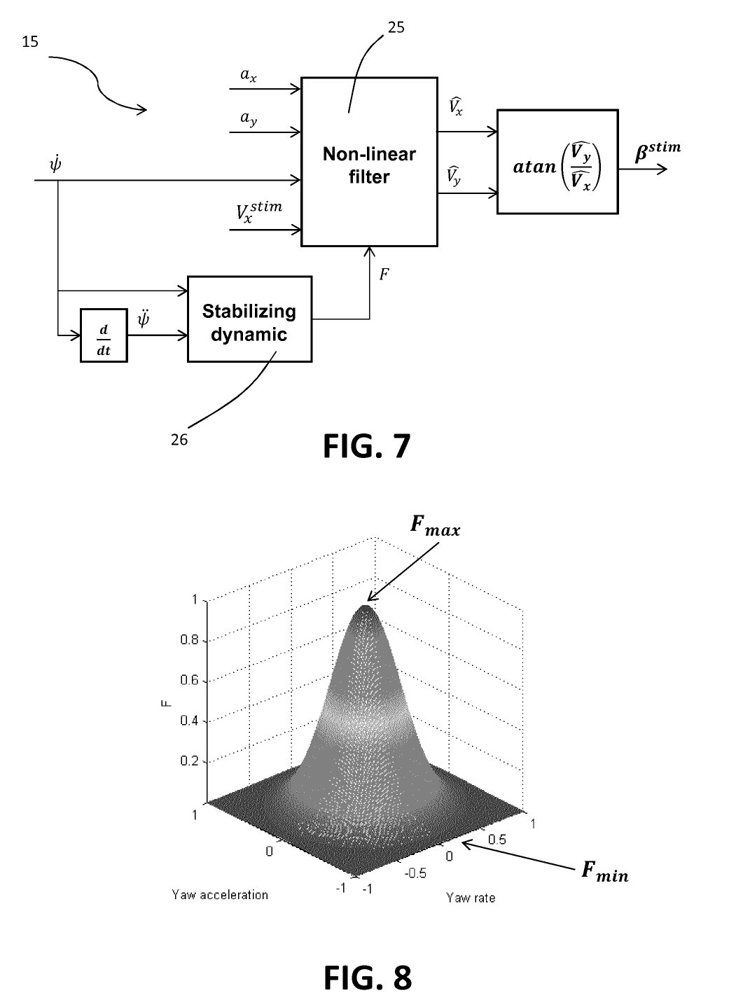

Turning now back again to FIG. 1, a detailed description of module 3, which actually determines an estimated side slip angle β^{stim}, will be now given. A detailed block diagram of module 3 is given in FIG. 7.

According to the embodiment of module 3 given in FIG. 7, the estimated side slip angle β^{stim} is determined on the basis of the corrected longitudinal acceleration aₓ, lateral acceleration a_{y} and yaw rate \dot{ψ} and on the basis of the estimated vehicle speed Vₓ^{stim}, calculated as described above. The estimated side slip angle β^{stim} is determined by a time-variant non-linear filter modeling the vehicle cinematic behavior on a curve, such as a Kalman Filter or a Luenberger Filter. With reference to the FIG. 7, the non-linear filter is shown as module 25 (“Non-linear filter”).

Many non-linear filters have been proposed describing the vehicle cinematic behavior on a curve. A general formula of such a non-linear filter can be the following one:

$$[ \begin{matrix}\dot{\hat{{V}_{x}}} ( t ) \\ \dot{\hat{{V}_{y}}} ( t )\end{matrix} ] = A ( \dot{ψ} ( t ) ) [ \begin{matrix}\hat{{V}_{x}} ( t ) \\ \hat{{V}_{y}} ( t )\end{matrix} ] + B [ \begin{matrix}{a}_{x} ( t ) \\ {a}_{y} ( t )\end{matrix} ] + K ( \dot{ψ} ( t ) ) ( {V}_{x}^{stim} ( t ) - ( t ) )$$

For example, a standard known non-linear filter can have the following formula:

$$[ \begin{matrix}{\dot{\hat{V}}}_{x} ( t ) \\ {\dot{\hat{V}}}_{y} ( t )\end{matrix} ] = \underbrace{[ \begin{matrix}0 & \dot{ψ} ( t ) \\ - \dot{ψ} ( t ) & 0\end{matrix} ]}_{A} [ \begin{matrix}{\hat{V}}_{x} ( t ) \\ {\hat{V}}_{y} ( t )\end{matrix} ] + \underbrace{[ \begin{matrix}1 & 0 \\ 0 & 1\end{matrix} ]}_{B} [ \begin{matrix}{a}_{x} ( t ) \\ {a}_{y} ( t )\end{matrix} ] + \underbrace{[ \begin{matrix}{α}_{1} \vert \dot{ψ} ( t ) \vert \\ {α}_{2} \dot{ψ} ( t )\end{matrix} ]}_{K} ( {V}_{x}^{stim} ( t ) - ( t ) )$$

wherein α₁, α₂ are filter fixed parameters and t indicates time. Solving the above non-linear system allows to determine in a predictive manner the vehicle accelerations

$$[ \begin{matrix}{\dot{\hat{V}}}_{x} ( t ) \\ {\dot{\hat{V}}}_{y} ( t )\end{matrix} ]$$

and the vehicle speeds

$$[ \begin{matrix}{\hat{V}}_{x} ( t ) \\ {\hat{V}}_{y} ( t )\end{matrix} ] .$$

Finally the side slip angle can be determined from the vehicle speeds

$$[ \begin{matrix}{\hat{V}}_{x} ( t ) \\ {\hat{V}}_{y} ( t )\end{matrix} ]$$

with the following formula:

$${β}^{stim} = a tan ( \frac{}{} )$$

However, using this standard non-linear filter the estimated side slip angle tends to diverge with time. Indeed, the model describes the vehicle behaviour on a curve which does not correspond to vehicle behaviour when the vehicle moves on a straight. In these running conditions lateral and longitudinal dynamics are not correlated and possible deviations due to external effects, such as road banking, or measurement errors, may arise.

Hence, according to the invention the estimated side slip angle β^{stim} is determined on the basis of the corrected longitudinal acceleration aₓ, lateral acceleration a_{y} and yaw rate \dot{ψ} and on the basis of the estimated vehicle speed Vₓ^{stim}, by a parametrical non-linear filter modeling the vehicle behavior on a curve, which filter is variable as a function of a parameter F depending from at least one of the yaw acceleration \ddot{ψ}, the yaw rate \dot{ψ} and the lateral acceleration ay, in such a manner that when the vehicle moves straight, the estimated lateral velocity \hat{V}_{y}(t) is driven close to zero.

Referring to the embodiment shown in FIG. 7, parameter F is determined in a module 26 (“Stabilizing dynamic”) on the basis of the yaw rate \dot{ψ} and of the yaw acceleration \ddot{ψ}, which in turn can be calculated as a derivative of the yaw rate \dot{ψ}, if not already available. Parameter F becomes then an input for module 25.

In accordance with an embodiment, the general formula of the non-linear filter depending from parameter F can be the following:

$$[ \begin{matrix}{\dot{\hat{V}}}_{x} ( t ) \\ {\dot{\hat{V}}}_{y} ( t )\end{matrix} ] = A ( \dot{ψ} ( t ) , F ( t ) ) [ \begin{matrix}{\hat{V}}_{x} ( t ) \\ {\hat{V}}_{y} ( t )\end{matrix} ] + B [ \begin{matrix}{a}_{x} ( t ) \\ {a}_{y} ( t )\end{matrix} ] + K ( \dot{ψ} ( t ) ) ( {V}_{x}^{stim} ( t ) - ( t ) )$$

which differs from a standard one mainly in that matrix A depends on parameter F.

For example the calculation can be based on the following non-linear filter:

$$[ \begin{matrix}{\dot{\hat{V}}}_{x} ( t ) \\ {\dot{\hat{V}}}_{y} ( t )\end{matrix} ] = \underbrace{[ \begin{matrix}0 & \dot{ψ} ( t ) \\ - \dot{ψ} ( t ) & - F\end{matrix} ]}_{A} [ \begin{matrix}{\hat{V}}_{x} ( t ) \\ {\hat{V}}_{y} ( t )\end{matrix} ] + \underbrace{[ \begin{matrix}1 & 0 \\ 0 & 1\end{matrix} ]}_{B} [ \begin{matrix}{a}_{x} ( t ) \\ {a}_{y} ( t )\end{matrix} ] + \underbrace{[ \begin{matrix}{α}_{0} + {α}_{1} \vert \dot{ψ} ( t ) \vert \\ {α}_{2} \dot{ψ} ( t )\end{matrix} ]}_{K} ( {V}_{x}^{stim} ( t ) - ( t ) )$$

wherein α₀, α₁, α₂ filter fixed parameters and t indicates time. Filter parameter α₀ can be possibly equal to zero.

When the vehicle is moving straight, both the yaw rate and the yaw acceleration are close to zero. Under these conditions, as explained above, in order to compensate the lateral velocity \hat{V}_{y}(t), parameter F must increase. In this manner, the negative component−F·\hat{V}_{y}(t) in the lateral acceleration [symbol] (t) determined by the filter increases, too. On the contrary, parameter F must be decreasing when the yaw rate, the yaw acceleration or both are high, i.e. when the vehicle is running on a curve. Only under these conditions, F is zero or tends to zero, thus the filter is or tends to be a standard non-linear filter of the type described above. In other words, the negative component−F·\hat{V}_{y}(t) in the lateral acceleration [symbol] (t) determined by the filter is zero or tends to be zero.

FIG. 8 shows a possible curve describing parameter F as a function of the yaw rate and of the yaw acceleration. As can be seen, parameter F is maximum (Fₘₐₓ) when both the yaw rate and the yaw acceleration are 0, and tends to zero (Fₘᵢₙ) when the yaw rate and/or the yaw acceleration increase. It is preferable that the transition from the maximum value Fₘₐₓ and the minimum value Fₘᵢₙ is as smooth as possible, because this results in a smooth transition between turning conditions (F=Fₘᵢₙ) and straight move conditions (F=Fₘₐₓ) in the filter.

For example, the parameter F can be described by a bivariate Gaussian distribution:

$$F ( \dot{ψ} ( t ) , \ddot{ψ} ( t ) ) = {F}_{min} + \frac{{F}_{max}}{2 π {σ}_{1} {σ}_{2} } {e}^{- \frac{1}{2} ( \frac{{\dot{ψ}}^{2}}{{σ}_{1}^{2}} + \frac{{\ddot{ψ}}^{2}}{{σ}_{2}^{2}} )}$$

wherein σ₁ and σ₂, represents covariance of the yaw rate range and the yaw acceleration range, respectively.

Solving the non-linear system allows to determine the accelerations

$$[ \begin{matrix}{\dot{\hat{V}}}_{x} ( t ) \\ {\dot{\hat{V}}}_{y} ( t )\end{matrix} ]$$

from which the speeds

$$[ \begin{matrix}{\hat{V}}_{x} ( t ) \\ {\hat{V}}_{y} ( t )\end{matrix} ]$$

can be obtained through integration (module 25). Finally the side slip angle can be determined with the following formula (module 26):

$${β}^{stim} = a tan ( \frac{}{} )$$

It is to be noted that, even though parameter F has been described as depending from both the yaw rate and the yaw acceleration, it can alternatively depend from the yaw rate or the yaw acceleration or the lateral acceleration, or combinations thereof, provided that the selected quantity/quantities allows/allow to determine if the vehicle is moving straight or on a curve, in such a manner that if the vehicle moves straight, parameter F reaches its maximum value Fₘₐₓ, and if the vehicle is moving on a curve, parameter F decreases until reaching its minimum value Fₘᵢₙ. Consequently, if it is determined that the vehicle is moving straight, the negative component−F·\hat{V}_{y}(t) added to the lateral acceleration [symbol] (t) in the filter reaches its maximum value.

The above described method can be implemented for example by a computer program directly downloadable in a working storage of a processing system for executing the steps of the method itself.

Such computer program can be for example loaded in a control unit of a vehicle.

Further, it is observed that the method according to the invention, besides being implemented by software, can be implemented by hardware devices or by a combination of hardware and software.

Finally, it is to be noted that, in the present description and in the appended claims, elements named “module” may be implemented using hardware devices (e.g. control units), software or a combination of hardware and software.

The skilled person, in order to satisfy specific contingent needs, may change the embodiments described so far, making several additions, modifications or replacements of elements with other functionally equivalent, without however departing from the scope of the appended claims.

1. Method for estimating the side slip angle (β^{stim}) of a four-wheeled vehicle, comprising:
detecting signals representing the vehicle longitudinal acceleration (Ax), lateral acceleration (Ay), vertical acceleration (Az), yaw rate (\dot{ψ}), roll rate (\dot{θ}), wheels speeds (V_{FL}, V_{FR}, V_{RL}, V_{RR});
pre-treating said signals in order to correct measurement errors and/or noises, so to obtain corrected measurements of at least the longitudinal acceleration (aₓ), the lateral acceleration (a_{y}), the yaw rate (\dot{ψ}) and the wheels speeds (ν_{FL}, ν_{FR}, ν_{RL}, ν_{RR});
determining an estimated vehicle longitudinal speed (Vₓ^{stim}) on the basis of at least one of the corrected measurements of the wheel speeds (ν_{FL}, ν_{FR}, ν_{RL}, ν_{RR});
determining a yaw acceleration (\ddot{ψ}) from the signal representing the yaw rate (\dot{ψ});
solving a time-depending parametrical non-linear filter, such as a Kalman filter or a Luenberger filter, describing the vehicle longitudinal and lateral speeds ( [symbol] , [symbol] ) and longitudinal and lateral accelerations ( [symbol] , [symbol] ) as a function of the corrected measurements of the longitudinal acceleration (aₓ), of the lateral acceleration (a_{y}), of the yaw rate (\dot{ψ}) and the estimated vehicle longitudinal speed (Vₓ^{stim}) and of a filter parameter (F) depending from at least one of the vehicle yaw acceleration (\ddot{ψ}), yaw rate (\dot{ψ}) and lateral acceleration (ay) which adds a negative component to the lateral acceleration ( [symbol] ) determined by the filter itself, said filter parameter (F) being selected such that said negative component reaches a maximum value when it is determined that the vehicle is moving straight on the basis of said at least one of the vehicle yaw acceleration (\ddot{ψ}), yaw rate (\dot{ψ}) and lateral acceleration (ay);
determining the vehicle estimated side slip angle (β^{stim}) from said longitudinal and lateral vehicle speeds ( [symbol] , [symbol] ) determined by solving the non-linear filter.

2. Method according to claim 1, wherein the non-linear filter has the following formula:
$$[ \begin{matrix}{\dot{\hat{V}}}_{x} ( t ) \\ {\dot{\hat{V}}}_{y} ( t )\end{matrix} ] = \underbrace{[ \begin{matrix}0 & \dot{ψ} ( t ) \\ - \dot{ψ} ( t ) & - F\end{matrix} ]}_{A} [ \begin{matrix}{\hat{V}}_{x} ( t ) \\ {\hat{V}}_{y} ( t )\end{matrix} ] + \underbrace{[ \begin{matrix}1 & 0 \\ 0 & 1\end{matrix} ]}_{B} [ \begin{matrix}{a}_{x} ( t ) \\ {a}_{y} ( t )\end{matrix} ] + \underbrace{[ \begin{matrix}{α}_{0} + {α}_{1} \vert \dot{ψ} ( t ) \vert \\ {α}_{2} \dot{ψ} ( t )\end{matrix} ]}_{K} ( {V}_{x}^{stim} ( t ) - ( t ) )$$
wherein α₀α₁, α₂ are filter fixed parameters and t indicates time.

3. Method according to claim 1, wherein the filter parameter (F) depends from the vehicle yaw acceleration (\ddot{ψ}) and yaw rate (\dot{ψ}) and is selected so to reach a maximum value (Fₘₐₓ) when both the yaw rate (\dot{ψ}) and the yaw acceleration (\ddot{ψ}) are zero, and to be zero or near zero as a minimum value (Fₘᵢₙ) when the yaw rate (\dot{ψ}) and/or the yaw acceleration (\ddot{ψ}) reach or tend to reach maximum thresholds in absolute value, the filter parameter (F) decreasing continuously from its maximum value to its minimum value.

4. Method according to claim 3, wherein the filter parameter (F) is described by a bivariate Gaussian distribution:
$$F ( \dot{ψ} ( t ) , \ddot{ψ} ( t ) ) = {F}_{min} + \frac{{F}_{max}}{2 {πσ}_{1} {σ}_{2}} {e}^{- \frac{1}{2} ( \frac{{\dot{ψ}}^{2}}{{σ}_{1}^{2}} + \frac{{\ddot{ψ}}^{2}}{{σ}_{2}^{2}} )}$$
wherein σ₁ and σ₂ represents covariance of the yaw rate range and of the yaw acceleration range, respectively.

5. Method according to claim 1, wherein pre-treating comprises filtering the signals representing the vehicle longitudinal acceleration (Ax), lateral acceleration (Ay), vertical acceleration (Az), yaw rate (\dot{ψ}) and roll rate (\dot{θ}).

6. Method according to claim 1, wherein pre-treating comprises: correcting the signals representing the vehicle longitudinal acceleration (Ax), lateral acceleration (Ay) and vertical acceleration (Az) by compensating static roll and/or pitch mounting and/or static yaw.

7. Method according to claim 1, wherein pre-treating comprises correcting the signals representing the longitudinal acceleration (Ax), the lateral acceleration (Ay) and the vertical acceleration (Az) on the basis of the distance of the longitudinal acceleration (Ax) lateral acceleration (Ay) and vertical acceleration (Az) sensor/sensors from the vehicle center of gravity and on the basis of the vehicle yaw rate (\dot{ψ}) and roll rate (\dot{θ}).

8. Method according to claim 1, wherein pre-treating comprises determining an estimated vehicle roll (θ^{stim}) on the basis of the lateral acceleration (Ay) and of the roll rate (\dot{θ}).

9. Method according to claim 8, wherein determining the estimated vehicle roll (θ^{stim}) comprises estimating an estimated static roll, estimating an estimated dynamic roll and summing the estimated static roll and the estimated dynamic roll, thereby obtaining the estimated vehicle roll (θ^{stim}), wherein:
determining the estimated static roll comprises:
determining a static roll corresponding to a static condition starting from the lateral acceleration (Ay) on the basis of a pre-determined relation between lateral acceleration (Ay) and static roll due to suspensions configuration and stiffness;
filtering the so-determined static roll in a high-pass filter;
subtracting the filtered static roll from the static roll determined form said pre-determined relation;
determining the estimated dynamic roll comprises:
filtering the roll rate (\dot{θ}) in a high-pass filter;
integrating the filtered roll rate.

10. Method according to claim 1, wherein pre-treating comprises: correcting the lateral acceleration (Ay) by compensating the effect of gravity (g) on the lateral acceleration (Ay) due to the vehicle roll (θ) on the basis of the estimated vehicle roll θ^{stim}.

11. Method according to claim 1, wherein pre-treating comprises determining offsets of the signals representing the yaw rate (\dot{ψ}) and/or the roll rate (\dot{θ}), comprising:
collecting samples of the signal representing the yaw rate (\dot{ψ}) and/or the roll rate (\dot{θ}) for a preselected time while maintaining the vehicle stopped;
calculating an exponentially weighted moving average of the samples collected, representing the yaw rate (\dot{ψ}) and/or the roll rate (\dot{θ}) offset.

12. Method according to claim 1, wherein pre-treating comprises: determining offsets of the signals representing the longitudinal acceleration (Ax), comprising:
collecting samples of the difference between the signal representing the longitudinal acceleration (Ax) and a reference longitudinal acceleration obtained as a derivative of a vehicle speed calculated on the basis of the signals representing the wheels speed for a preselected time while the vehicle is moving;
excluding the collected samples if:
the vehicle speed exceeds a predetermined vehicle speed value; and/or
the longitudinal acceleration (Ax) exceeds a predetermined vehicle longitudinal acceleration value; and/or
the yaw rate (\dot{ψ}) exceeds a predetermined vehicle yaw rate value;
calculating an exponentially weighted moving average of the non-excluded samples collected, representing the longitudinal acceleration offset.

13. Method according to claim 1, wherein pre-treating comprises: determining offsets of the signal representing the lateral acceleration (Ay), comprising:
collecting samples of the difference between the signal representing the lateral acceleration (Ay) and a reference lateral acceleration obtained as a multiplication of a vehicle speed calculated on the basis of the signals representing the wheels speed and the yaw rate (\dot{ψ}) for a preselected time while the vehicle is moving;
excluding collected samples if:
the vehicle speed exceeds a predetermined vehicle speed value; and/or
the yaw rate (\dot{ψ}) exceeds a predetermined vehicle yaw rate value;
calculating an exponentially weighted moving average of the non-excluded samples collected, representing the lateral acceleration offset.

14. Method according to claim 1, wherein pre-treating comprises: filtering the signals representing wheels speeds (V_{FL}, V_{FR}, V_{RL}, V_{RR}), the corrected measurements of the wheel speeds (ν_{FL}, ν_{FR}, ν_{RL}, ν_{RR}) corresponding to the filtered signals of the wheel speeds.

15. Method according to claim 1, wherein determining the estimated vehicle longitudinal speed (Vₓ^{stim}) comprises:
detecting a signal representing the steering angle (δ);
determining the estimated vehicle longitudinal speed (Vₓ^{stim}) on the basis of the corrected measurements of the wheel speeds, the steering angle (δ) and the yaw rate (\dot{ψ}).

16. Method according to claim 15, wherein determining the estimated vehicle longitudinal speed (Vₓ^{stim}) comprises:
calculating a first estimated vehicle speed (V_{FL}^{st}) as a projection of the detected front left wheel speed (V_{FL}) on the vehicle longitudinal axis (X) on the basis of the steering angle (δ);
calculating a second estimated vehicle speed (V_{FR}^{st}) as a projection of the detected front right wheel speed (V_{FR}) on the vehicle longitudinal axis (X) on the basis of the steering angle (δ);
calculating a third estimated vehicle speed (V_{FL}^{comp}) starting from the first estimated vehicle speed (V_{FR}^{st}) by subtracting the speed component due to the yaw rate (\dot{ψ});
calculating a fourth estimated vehicle speed (V_{FR}^{comp}) starting from the second estimated vehicle speed (V_{FR}^{st}) by subtracting the speed component due to the yaw rate (\dot{ψ});
calculating a fifth estimated vehicle speed (V_{RL}^{comp}) starting from the detected rear left wheel speed (V_{RL}) by subtracting the speed component due to the yaw rate (\dot{ψ});
calculating a sixth estimated vehicle speed (V_{RR}^{comp}) starting from the detected rear right wheel speed (V_{RR}) by subtracting the speed component due to the yaw rate;
calculating the estimated vehicle speed (Vₓ^{stim}) as:
the minimum speed among the third, fourth, fifth, and sixth estimated vehicle speeds if the vehicle is longitudinally accelerating;
the maximum speed among the third, fourth, fifth, sixth estimated vehicle speeds if the vehicle is longitudinally decelerating;
the mean value of the third, fourth, fifth, sixth estimated vehicle speeds if the vehicle is moving at a longitudinal constant speed or having a longitudinal acceleration comprised between an upper positive and a lower negative acceleration threshold.

17. Computer program loadable in a control unit of a vehicle to carry out the method according to claim 1.

18. Control unit for a vehicle, in which a computer program to carry out the method according to claim 1 is loaded.

19. Vehicle comprising a control unit in which a computer program to carry out the method according to claim 1 is loaded.
